(19) United States
(12) Patent Application Publication
(10) Pub. No.: US 2002/0087974 A1
(43) Pub. Date: Jul. 4, 2002

(54) System and method of providing relevant interactive content to a broadcast display

(76) Inventor: Michael Sprague, New York, NY (US)

Correspondence Address: BOURQUE & ASSOCIATES, P.A., Suite 301, 835 Hanover Street, Manchester, NH, 03104, US

(21) Appl. No.: 10/003,484

(22) Filed: Oct. 19, 2001

Related U.S. Application Data
(60) Provisional application No. 60/241,931, filed on Oct. 20, 2000.

(51) Int. Cl. H04N 7/10

(52) U.S. Cl. 725/32

(57) ABSTRACT

A system and method of displaying interactive content relevant to a broadcast presentation on a viewer display associated with a viewer device. The method begins with the receipt, at said viewer device, of a broadcast presentation from a broadcast presentation provider. Next, the viewer device receives relevant interactive content from a source of interactive content, filtered and characterized for a specific user. This additional content is bound to the broadcast content only by nature of a relevancy mapping. As such, it may be presented to the user without the broadcast content providers direct assistance. The viewer device merges the broadcast presentation and the relevant interactive content and displays both the broadcast presentation and the relevant interactive content on a viewer display. Preferably, the viewer device accesses the source of relevant interactive content over a computer network, such as the Internet.

### FIELD OF THE INVENTION

The present invention relates generally to a system and method of providing interactive content to a broadcast program display to enhance the viewing experience of a viewer of the broadcast program. More particularly, the present invention concerns determining the nature of a broadcast program being viewed by a user and the location of the person viewing the broadcast content, in order to access a source of interactive content over a computer network, perform a search of the interactive content source while applying rules affecting the search to retrieve any interactive content associated with the broadcast program being viewed by the user, and to coordinate transmission of any retrieved interactive content to the viewer and display of the interactive content on a viewer display under the control of the viewer.

### BACKGROUND OF THE INVENTION

Prior art systems are known which integrate television broadcasts with other video or audio content such as a stream of data broadcast over the internet. Although such merged displays may be interactive, they require action on the part of the broadcast program provider and cannot be dynamically created and controlled by alternate uncoordinated content providers or a community of viewers or an individual viewer of a broadcast program.

### SUMMARY OF THE INVENTION

Accordingly, the present invention provides a system and method of displaying interactive content relevant to a broadcast presentation on a viewer display associated with a viewer device. The method begins with the receipt, at the viewer device, of a broadcast presentation from a broadcast presentation provider. Next, the viewer device receives relevant interactive content from a source of interactive content, filtered and characterized for a specific user. This additional content is bound to the broadcast content only by nature of a relevancy mapping. As such, it may be presented to the user without the broadcast content providers direct assistance, intervention or even knowledge.

The viewer device merges the broadcast presentation and the filtered and characterized relevant interactive content and displays both the broadcast presentation and the relevant interactive content on a viewer display. Preferably, the viewer device accesses the source of relevant interactive content over a computer network, such as the Internet.

The method of searching and retrieving identified interactive content relevant to said identified broadcast presentation utilizes a dynamically programmable and interdependent rule system including at least one rule from a group including, for example, a rule limiting content to specific broadcast programming; a rule limiting content to authorized users; a rule limiting content to user affinity with an identified group of authorized users; a rule limiting content to a specific geographical location; and a rule limiting content to broadcaster permission. The dynamically programmable and interdependent rule system typically would operate automatically without user or viewer intervention.

### DESCRIPTION OF THE DRAWINGS

The present invention will be better understood by reading the following detailed description, taken together with the drawings wherein:

FIG. 1 is a schematic diagram of one exemplary system embodying the principles of the present invention, wherein a viewer of a broadcast program accesses a source of interactive information associated with the broadcast program over a computer network;

FIG. 2 is diagram showing the multiple layers that are displayed on a viewer display device;

FIG. 3 shows a converged display including the multiple layers of FIG. 2, including a background layer for displaying a broadcast program and an interactive content overlay layer;

FIG. 4 shows an alternative display strategy for windowing multiple sources of information on a display device; and

FIG. 5 is a flow chart of one exemplary method of providing interactive content to a broadcast program.

### DETAILED DESCRIPTION OF THE PREFERRED EMBODIMENT

A system 10, FIG. 1, on which the present invention can be utilized and which embodies the present invention, includes a multi-media presentation system 12 maintained by a system user. (The term user and viewer will be used interchangeably in the remainder of this description and should be construed to mean a person who perceives a broadcast presentation using his or her senses, including but not limited to sight and/or hearing.) The term multi-media presentation system is used herein to indicate a system capable of presenting audio with or without video information to a user. However, the presentation of more than one media should not be construed as a limitation of the present invention. Examples of such multi-media presentation systems 12 include personal computer (PC) systems, PC televisions (PCTVs), televisions used in combination with set-top boxes, and the like.

Each multi-media presentation system or workstation 12 includes a viewer computer 14 and at least one viewer display device 16, such as a computer monitor or television set. Each multi-media presentation system 12 also includes at least one input device 18, such as a keyboard, mouse, digitizer pad, writing pad, microphone, camera or other pointing or input generating device which allows the user to provide user input the workstations 12.

As will be described more fully below, each multi-media presentation system 12 is adapted to receive at least one broadcast presentation signal 20, which may be provided in the form of broadcast television programming (including standard broadcast television received with an antenna, cable and satellite television), closed circuit television, Internet web-TV or a broadcast like signal received from a device such as a storage device (hard drive, DVD, CD ROM), cassette tape, VCR tape or the like, received by means of a standard television broadcast signal over the air waves, cable television or satellite television, utilizing a tuner or other method in each viewer computer 14.

In addition, in one preferred embodiment, each multi-media presentation system 12 interfaces with a computer network 40, which may be provided in the form of a local area network (LAN), a wide area network (WAN), a telephone (wireless) network or a global computer network, such as the Internet running a communication protocol such as Internet Protocol (IP).

The heart of the multi-media presentation system 12 is the viewer computer 14. Each viewer computer 14 includes a central processing unit (CPU) 22, which controls the functions of the presentation system. The CPU 22 interfaces a broadcast receiver 24, which is associated with the viewer computer 14. The broadcast receiver 24 receives, as its input, the broadcast program signal 20. In one embodiment, the broadcast receiver 24 is a broadcast channel tuner that receives broadcast signals from a source such as a television broadcasting station or other programming provider or source.

In another embodiment, the broadcast receiver 28 is a PC tuner card included in the viewer computer, which provides television functionality to the viewer computer 14. In another embodiment, the broadcast receiver is an IP enabled device (such as a cable modem) attached or integrated with the viewer computer 14.

Each viewer computer 14 also includes a communication controller 26 to control inputs received from, and outputs transmitted to, the computer network 40. In one preferred embodiment, the communications controller 26 may include a device such as a modem (for example, a telephone or cable modem) or a network interface card that receives information from a local or wide area network.

Each viewer computer 14 may also include internal storage 28, such as memory, disk drive, CD-Rom, tape or the like, where information relevant to a displayed broadcast presentation may be stored.

A dynamic display controller 30 (also known as a broadcast browser) is also provided with each viewer computer 14. The dynamic display controller 30 interfaces the CPU 22, broadcast receiver 24 and communications controller 26 and system storage 28 and receives, as input, a broadcast presentation in the form of broadcast signal 20, information stored in system storage 28 and additional information from the computer network 40 (via the communication controller 26). The dynamic display controller 30 merges the multiple input signals and outputs a merged data signal to the display device 16.

In the preferred embodiment of the present invention, which is disclosed for illustrative purposes only and not considered a limitation of the present invention, the dynamic display controller 30 is implemented as computer software in the form of a browser user interface operating on the viewer computer 14, which is a personal computer or individual computer workstation.

Each multi-media presentation system 12 also includes at least one input device 18, which allows a viewer to provide input to the dynamic display controller 30, which will be explained in greater detail below.

In the exemplary embodiment of FIG. 1, a source of interactive content 42 is accessible to the multi-media presentation system 12 via the computer network 40. In the illustrative example, the source of interactive content 42 includes an interactive content database 44 that is controlled by a remote, interactive content server 46. In this embodiment, when a viewer is viewing a broadcast presentation 20 on his or her display device 16, he or she may also, simultaneously, view interactive content that is relevant to the broadcast presentation 20 being viewed.

In order to ensure that the interactive content is, in fact, relevant to the broadcast presentation, information identifying and characterizing the broadcast presentation must be provided to the interactive content server 46. The present invention contemplates a number of means by which such identifying and characterizing information can be provided to the interactive content server. For example, a viewer may provide identifying information to his or her viewer computer 14 using input device 20.

Alternatively, the CPU 22 querying the broadcast receiver 24 to identify the source of the broadcast signal 20 being viewed may identify the broadcast presentation being viewed. The CPU may then determine from the date and time, that the particular broadcast presentation 20 is being viewed and the source of the broadcast, including the identity of the broadcast presentation. In another example, a location of the viewer's computer, coupled with the date, time and received channel can be used to identify the broadcast presentation being viewed. Location information can be obtained by, for example, a zip code input provided by the viewer to the viewer computer via input device 18, a GPS receiver attached to the viewer computer, or a local transmitter identifier such as could be provided by a cell phone network transmitter.

Once the broadcast presentation is identified, an identifier is provided to the source of interactive content, such as the interactive content database 44 via the interactive content server 46 and computer network 40. When the interactive content server 46 receives the identifying information for the broadcast presentation being viewed, it will search the interactive content database 44 while applying rules affecting the search and retrieve any interactive content that is relevant to the identified broadcast presentation.

In the embodiment of FIG. 1, the source of interactive content is accessed over a computer network and preferably, the Internet. Thus, any viewer computer that is capable of transmitting and receiving information in hypertext transfer protocol (http) can access the source of interactive content 42 over the Internet. Though the http protocol is used for illustrative purposes, the usage of alternate protocols, including protocols not yet developed, is envisioned in future embodiments and considered within the scope of the present invention.

Once retrieved, filtered and characterized for the particular user, the relevant interactive content is then provided, from the interactive content source 42, to the viewer computer 14, where the communication controller 26 receives it. The dynamic display controller 30 thereafter merges the received relevant interactive content with the broadcast presentation and displays both on the viewer display 16.

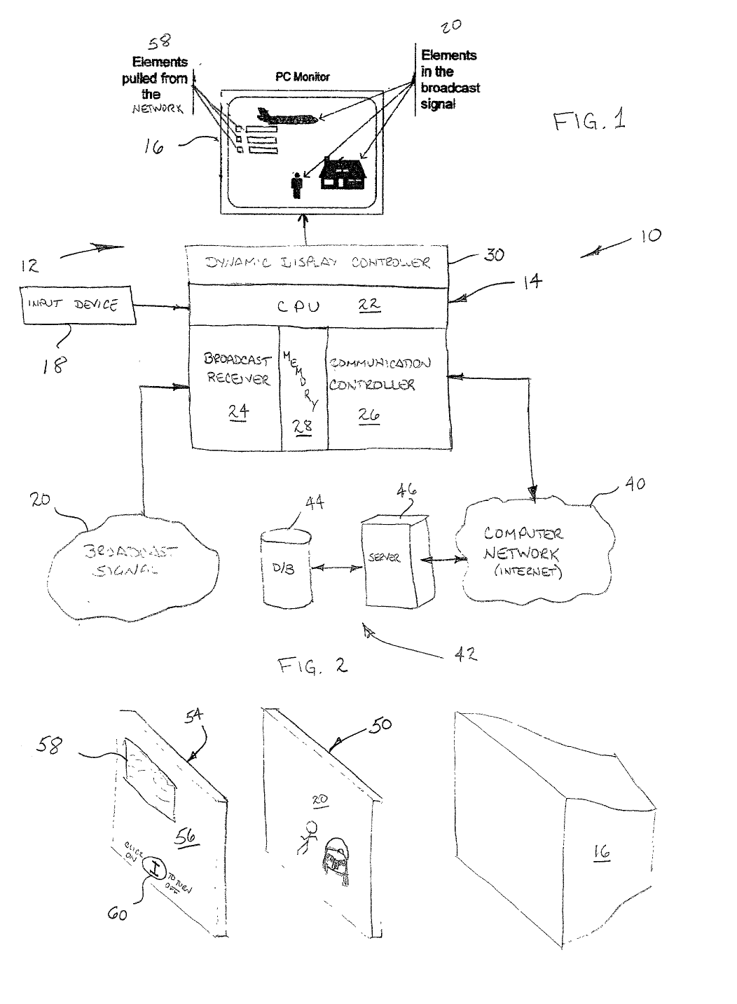

FIGS. 2 and 3 show an example of one display strategy that may be utilized by the dynamic display controller 30. Such a layering or “overlay” strategy may utilized by the dynamic display controller 30 to control the display of the broadcast presentation and the filtered and characterized relevant interactive content so that all of the data may be displayed in a single window or screen on each display device 16 for a given user or viewer.

The dynamic display controller 30 displays the broadcast presentation in a “background” layer 50. Next, an overlay is displayed in the same window in at least one additional layer 54 on top of the background layer 50. (It is understood that the order or layers can be reversed, if desired.) In order to allow the broadcast signal in the background layer 50 to be visible through the second layer 54, the second layer utilizes a substantially transparent background 56 or, as is disclosed herein, a background referred to by name as “broadcast” to signify the source of the background information.

In one embodiment, the dynamic display controller 30 may automatically display, in at least one of the additional layers 54, the filtered and characterized relevant interactive content 58 that it received from the interactive content source 42, in this example over computer network 40. Examples of interactive content include additional information regarding a product being displayed in the broadcast presentation, information regarding characters or actors or actresses appearing in the broadcast presentation and the like, all such content filtered and targeted for the particular viewer based or various criteria, as set forth above.

Relevant interactive content 58 could also include information allowing a viewer of the broadcast presentation to affect a purchase of an item that is being displayed in the broadcast presentation. In such a case, in addition to providing the relevant interactive content, input can be solicited from the viewer in one or more viewer input window 62 (FIG. 4).

In another embodiment, an interactive content icon 60 may also be provided and will appear when interactive content is available to allow a viewer to control when and if relevant interactive content is to be displayed on his or her display device 16 during a broadcast presentation. Thus if a viewer wishes to enhance his or her viewing experience, he or she can activate the display of relevant interactive content by selecting the interactive content icon 62. Conversely, if a viewer believes that interactive content would hinder his or her viewing experience, he or she can prohibit the display of interactive content by de-selecting the interactive content icon 62.

The embodiment of FIG. 4 utilizes a different display strategy than the embodiment of FIG. 3. In this embodiment, instead of using a layered display strategy, a windowed strategy is used. In the windowed strategy, the dynamic display controller displays the broadcast presentation 20 is a first window 64. Any retrieved relevant interactive content is then displayed in at least one additional window 66. Of course, multiple additional windows may be utilized.

For example, a first additional window may be provided to provide relevant interactive content about a product or service. The first additional window may have user-selectable icons that could trigger the display of a second or subsequent additional window if additional information or interaction between the viewer and the interactive content source is desired, such as, for example if a viewer wishes to purchase a product or service. Of course, each window may be sized and positioned in order to optimize the display of all of the information on the display device.

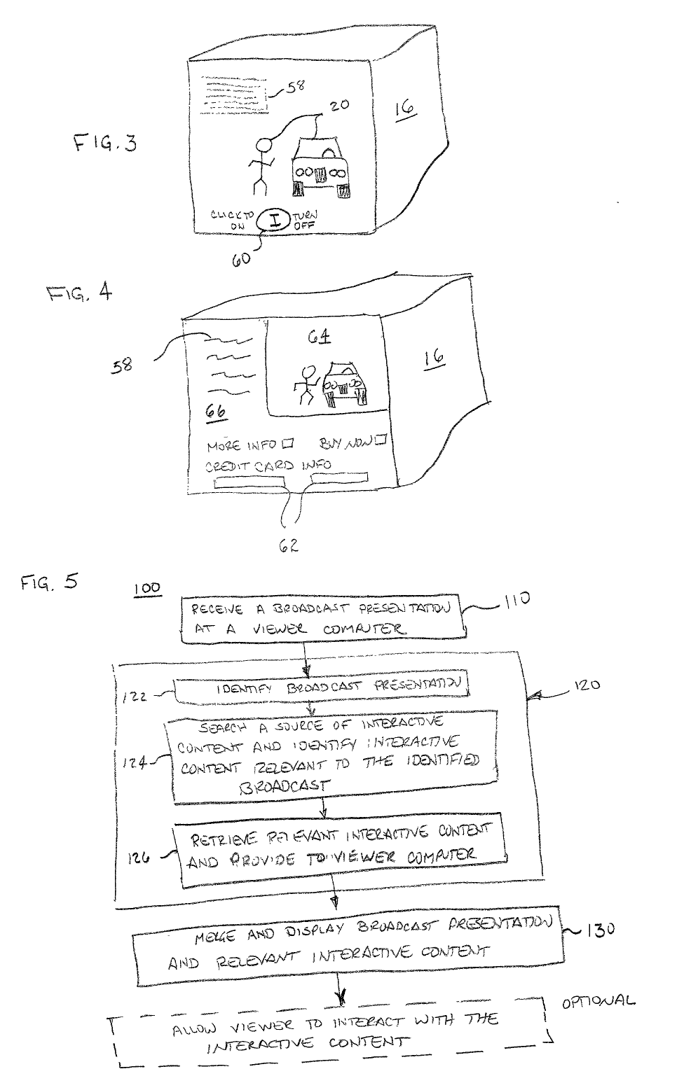

A method 100 of displaying interactive content relevant to a broadcast presentation on a viewer display is shown in FIG. 5. In order to utilize the method, a viewer will have a viewer computer that is capable of receiving a broadcast presentation. For example, a viewer may have a personal computer, PC TV or a set-top box associated with his or her television. Each viewer computer will include a display controller for controlling a display device and, in the preferred embodiment, a communication controller for interfacing the viewer computer with a source of interactive content over a computer network. However, the invention contemplates the use of other sources of interactive content, including a database that is included in storage of the viewer computer, in which case, a communication controller would not be required.

The method 100 begins by receiving a broadcast presentation at the viewer computer, act 110. Next, in act 120, relevant interactive content is also provided to the viewer computer. Then, in act 130, the broadcast presentation and interactive content are merged by a dynamic display controller and are displayed on a display device.

In the preferred embodiment, the viewer computer accesses a remote source of interactive content over a computer network. Since the source of interactive content is envisioned to be made available to any viewer computer that can access the computer network, a method of ensuring that only interactive content that is relevant to the broadcast presentation and appropriate to the user is provided to the viewer computer for display. To ensure that only relevant interactive content is displayed, the broadcast presentation must first be identified, act 122. For example a viewer may simply provide information to his or her viewer computer identifying the broadcast presentation.

Alternatively, the viewer computer can automatically or semi-automatically identify the broadcast presentation being viewed by monitoring the source of the broadcast presentation (e.g. television channel being viewed) along with the date, time and geographic location of the viewer (e.g. using zip code or other geographically specific information previously entered/stored or dynamically determined on the viewer's display system). In the case of cable television broadcasting, viewing date, time and cable provider may provide sufficient information to identify the broadcast presentation.

Once the broadcast presentation is identified, then, in act 124, a source of interactive content is searched to identify any interactive content relevant to the broadcast presentation. If relevant interactive content is identified, then it is retrieved from the interactive content source and transmitted to the viewer computer, act 126, preferably over a computer network, such as the Internet.

The method 100 optionally allows for viewer interaction with the interactive content, act 140, by, for example providing information to the interactive content source using one or more input device. Any input information would then be transmitted to the interactive content source over the computer network.

Accordingly, the disclosed invention provides a system and method of providing and displaying, on a viewer's display device, interactive content that is specifically relevant to a broadcast presentation and to a particular viewer.

Modifications and substitutions by one of ordinary skill in the art are considered to be within the scope of the present invention, which is not to be limited except by the claims that follow.

What is claimed is:

1. A system for providing interactive content to a broadcast presentation being displayed on a viewer display associated with a viewer device, said system comprising:
a broadcast receiver associated with said viewer device, said broadcast receiver receiving a broadcast presentation from a broadcast presentation provider;
a communication controller associated with said viewer device, said communication controller receiving interactive content associated with said received broadcast presentation from a source of interactive content; and
a dynamic display controller associated with said viewer computer, said dynamic display controller responsive to said received broadcast presentation and said received interactive content, for displaying said broadcast presentation and said interactive content on a viewer display.

2. The system of claim 1, wherein said viewer display comprises a single-window layered display having:
a broadcast layer, for displaying said broadcast presentation in a background layer of said layered display; and
at least one overlay displayed in at least a second layer of said layered display on top of said broadcast layer on said single-window, layered display, said at least one overlay including said interactive content and having a substantially transparent background and allowing said broadcast presentation in said broadcast layer to be viewed through said at least one overlay.

3. The system of claim 1, wherein said source of interactive content comprises an interactive content server and at least one interactive content database, accessible over a computer network, and wherein said communication controller comprises a network controller.

4. The system of claim 3, wherein said computer network comprises a local area network (LAN)

5. The system of claim 3, wherein said computer network comprises a wide area network (WAN).

6. The system of claim 5, wherein said WAN comprises the Internet.

7. The system of claim 3, further comprising a broadcast presentation identifier identifying said broadcast presentation and a relevancy processor for identifying interactive content relevant to said identified broadcast presentation stored in said at least one interactive content database.

8. The system of claim 2 further comprising a viewer-selectable interactive content icon displayed on said at least one overlay, to allow a viewer to control the display of interactive content on said at least one overlay.

9. The system of claim 1, further comprising at least one input device for allowing a viewer of said broadcast presentation and interactive content to interact with said interactive content.

10. The system of claim 1, wherein said viewer display comprises a multi-window display having:
a first window, displaying said broadcast presentation; and
at least one additional window displaying said interactive content.

11. A method of displaying interactive content relevant to a broadcast presentation and relevant to a viewer on a viewer display associated with a viewer device, said method comprising the acts of:
receiving, at said viewer device, a broadcast presentation from a broadcast presentation provider;
receiving, at said viewer device, relevant interactive content from a source of interactive content; and
merging and displaying said retrieved broadcast presentation and relevant interactive content on a viewer display device.

12. The method of claim 11, wherein said act of receiving relevant interactive content comprises:
identifying said broadcast presentation received at said viewer device;
identifying at least one characteristic about said viewer;
responsive to identifying said broadcast presentation and identifying at least one characteristic about said viewer, searching a database of interactive content to identify any interactive content relevant to said identified broadcast presentation and to said at least one characteristic about said viewer; and
retrieving said identified relevant interactive content.

13. The method of claim 11, wherein said act of receiving relevant interactive content comprises:
identifying said broadcast presentation received at said viewer device;
identifying at least one characteristic about said viewer;
accessing a remote database of interactive content over a computer network;
searching a database of interactive content to identify any interactive content relevant to said identified broadcast presentation and to said at least one characteristic about said viewer; and
transmitting said relevant interactive content to said viewer device over said computer network.

14. The method of claim 13, wherein said acts of accessing said remote database of interactive content and transmitting said relevant interactive content over a computer network comprises accessing said remote database and transmitting said relevant interactive content over the Internet.

15. The method of claim 11, wherein said act of merging and displaying said retrieved broadcast presentation and relevant interactive content on said viewer display device comprises displaying said broadcast presentation and said relevant interactive content on a single-window layered display wherein:
said broadcast presentation is displayed in a broadcast layer, said broadcast layer being a background layer of said layered display; and
said relevant interactive content is displayed in at least one overlay in at least a second layer of said layered display on top of said broadcast layer on said single-window, layered display, said at least one overlay having a substantially transparent background and allowing said broadcast presentation in said broadcast layer to be viewed through said at least one overlay.

16. The method of claim 11, wherein said act of merging and displaying said retrieved broadcast presentation and relevant interactive content on said viewer display device comprises displaying said broadcast presentation and said relevant interactive content on a multi-window display wherein:
said broadcast presentation is displayed in a first window of said multi-window display; and
said relevant interactive content is displayed in at least one additional window of said multi-window display.

17. The method of claim 12, wherein said act of identifying said broadcast presentation received at said viewer device comprises receiving a viewer input containing an identifier for said received broadcast presentation.

18. The method of claim 12, wherein said act of identifying said broadcast presentation received at said viewer device comprises identifying said source of said received broadcast presentation, determining a date and time of receipt of said broadcast presentation and searching a schedule of broadcast presentations.

19. The method of claim 12, wherein said act of identifying said broadcast presentation received at said viewer device comprises identifying attributes of said broadcast presentation received at said viewer device, said attributes including a geographic location of said viewer device, a date and time of receipt of said broadcast presentation, and searching a database of broadcast presentations to identify a broadcast presentation corresponding to the attributes identified for said broadcast presentation received at said viewer device.

20. The method of claim 19, wherein said act of identifying a geographic location of said viewer device comprises inputting, at said viewer device a zip code associated with a location of said viewer device.

21. The method of claim 12, wherein said acts of searching and retrieving said identified interactive content relevant to said identified broadcast presentation utilizes a dynamically programmable and interdependent rule system including at least one rule selected from the group consisting of:
a rule limiting content to specific broadcast programming;
a rule limiting content to authorized users;
a rule limiting content to user affinity with an identified group of authorized users;
a rule limiting content to a specific geographical location; and
a rule limiting content to broadcaster permission.

22. The method of claim 21, wherein said dynamically programmable and interdependent rule system operates automatically.
